(19) United States
(12) Patent Application Publication
(10) Pub. No.: US 2025/0379610 A1
(43) Pub. Date: Dec. 11, 2025

(54) DUTY-CYCLE-BASED RECEIVER WITH LISTENING POWER CONSUMPTION REDUCTION

(71) Applicant: Silicon Laboratories Inc., Austin, TX (US)

(72) Inventors: Wentao Li, Mountain House, CA (US); Ameya Deepak Tudavekar, Jersey City, NJ (US); Xun Yang, Austin, TX (US)

(21) Appl. No.: 18/736,841

(22) Filed: Jun. 7, 2024

(51) Int. Cl. H04B 1/7093

(52) U.S. Cl. CPC H04B 1/7093; H04B 2201/7071

(57) ABSTRACT

A Direct Sequence Spread Spectrum (DSSS) receiver operates in a duty-cycle mode to reduce power consumption of the DSSS receiver. The DSSS receiver uses fast DSSS preamble detection to determine if an incoming signal is a desired channel DSSS preamble symbol and uses one preamble symbol to determine if an incoming signal is a desired channel DSSS preamble symbol. In the duty cycle mode of operation, the DSSS receiver further reduces power consumption by selectively disabling at least one power domain of a plurality of power domains of the DSSS receiver during an on-time of a duty cycle when a desired signal is not detected and by selectively disabling at least one power domain of the DSSS receiver during an off-time of the duty cycle.

### BACKGROUND

### Field of the Invention

This application relates to wireless communications and particularly to reducing power consumption of wireless receivers.

### Description of the Related Art

A typical Internet of Things (IoT) wireless communications device-based product is operable using any of multiple wireless protocols such as IEEE Standard. 802.15.4 based protocols (Zigbee® and Thread) and Bluetooth® Low Energy/Bluetooth (BLE/BT). According to the requirements of 2.4 GHz physical interface specification of the IEEE Std. 802.15.4, a Direct Sequence Spread Spectrum (DSSS) technique is used to reduce effects of interference by spreading four bits into 32-chip PN sequences. The IEEE Std. 802.15.4 is specifically designed to satisfy needs for low power consumption, cost-effective, standard-compliant solutions. In a typical application compliant with this standard, wireless communications devices are battery powered, and frequent battery replacement or recharging is impractical making power consumption a significant concern. Thus, techniques that reduce power consumption of a DSSS receiver are desired.

### SUMMARY OF EMBODIMENTS OF THE INVENTION

In at least one embodiment, a duty-cycling-based DSSS receiver utilizes fast DSSS preamble arrival detection, which uses only one preamble symbol to determine if an incoming signal is a desired channel DSSS preamble symbol, to operate the receiver in a power duty-cycling mode in a receiver search state to achieve lower average power consumption. The power duty-cycling mode is compliant with multiple wireless protocols, e.g., IEEE 802.15.4 based protocols Zigbee and OpenThread.

In an embodiment, a method for operating a wireless communications device includes periodically enabling a radio frequency receiver circuit. The radio frequency receiver circuit is partitioned into a plurality of power domains. The method includes controlling power consumption of the radio frequency receiver circuit by selectively disabling at least one of the plurality of power domains during an on-time of the radio frequency receiver circuit. The power consumption is controlled based on signal arrival detection and an average received signal power. The method may include determining the average received signal power based on a comparison of a predetermined threshold to a moving average of an estimated instantaneous power of the received signal. Controlling the power consumption may include configuring the radio frequency receiver circuit in a packet receive state. The power consumption may be controlled further based on detection of a synchronization word in a received packet. Controlling the power consumption may include disabling at least one of the plurality of power domains in response to detecting an end of packet.

In at least one embodiment, a wireless communications device comprises a radio frequency receiver circuit configured to generate a signal arrival detection signal and an average received signal power signal. The radio frequency receiver circuit is partitioned into a plurality of power domains. The wireless communications device comprises a controller configured to periodically enable the radio frequency receiver circuit and configured to generate a power domain control signal for at least one of the plurality of power domains of the radio frequency receiver circuit based on the signal arrival detection signal and the average received signal power signal. The demodulator circuit may be further configured to determine average received signal power based on a comparison of a predetermined threshold to a moving average of an estimated instantaneous power of a received signal. The demodulator circuit may be further configured to detect a synchronization word in a received packet and the power domain control signal may be further based on an indication of detection of the synchronization word. The controller may be further configured to disable a power domain of the plurality of power domains prior to detection of the synchronization word and to enable the power domain in response to the detection of the synchronization word. The controller may be further configured to disable at least one of the plurality of power domains in response to a timeout of a synchronization word detection window.

### BRIEF DESCRIPTION OF THE DRAWINGS

The present invention may be better understood, and its numerous objects, features, and advantages made apparent to those skilled in the art by referencing the accompanying drawings.

FIG. 1 is a table showing an exemplary symbol-to-chip mapping for the 2450 MHz and 2380 MHz frequency bands of an exemplary Offset-Quadrature Phase Shift Keying (O-QPSK) physical interface of a wireless communications network.

FIG. 2 illustrates a packet structure for transmission using the exemplary O-QPSK physical interface of a wireless communications network.

FIG. 3 illustrates the offset between I-phase and Q-phase chip modulation.

FIG. 4 illustrates a sample baseband chip sequence (the zero sequence) with half-sine pulse shaping.

FIG. 5 illustrates a functional block diagram of an embodiment of a duty-cycle-based receiver of a wireless communications device including an exemplary non-coherent DSSS demodulator consistent with at least one embodiment of the invention.

FIG. 6 illustrates an exemplary O-QPSK packet and particularly preamble and Start of Frame Delimiter (SFD) portions of a packet used for signal detection and timing by the duty-cycle-based receiver of FIG. 5.

FIG. 7A illustrates a functional block diagram of an embodiment of a power detector of the duty-cycle-based receiver of FIG. 5.

FIG. 7B illustrates associated signal levels for an embodiment of a power detector of the duty-cycle-based receiver of FIG. 5.

FIG. 8 illustrates exemplary waveforms for the power detector of FIG. 7.

FIG. 9 illustrates timing diagrams for duty-cycle timing for one channel scan by the duty-cycle-based receiver of FIG. 5.

FIG. 10 illustrates a high-level flow diagram consistent with at least one embodiment of the duty-cycle-based receiver of FIG. 5.

The use of the same reference symbols in different drawings indicates similar or identical items.

### DETAILED DESCRIPTION

Since a Direct Sequence Spread Spectrum (DSSS) receiver typically spends more time waiting and searching for a desired channel DSSS signal (referred to as a “receiver search state”) than time actually receiving the signal, the DSSS receiver operates in a duty-cycle mode to reduce power consumption of the DSSS receiver. The DSSS receiver uses fast DSSS preamble detection to determine if an incoming signal is a desired channel DSSS preamble symbol and uses one preamble symbol to determine if an incoming signal is a desired channel DSSS preamble symbol. In the duty cycle mode of operation, the DSSS receiver further reduces power consumption by selectively disabling at least one power domain of a plurality of power domains of the DSSS receiver during an on-time of a duty cycle when no preamble is detected and by selectively disabling at least one power domain of the DSSS receiver during an off-time of the duty cycle.

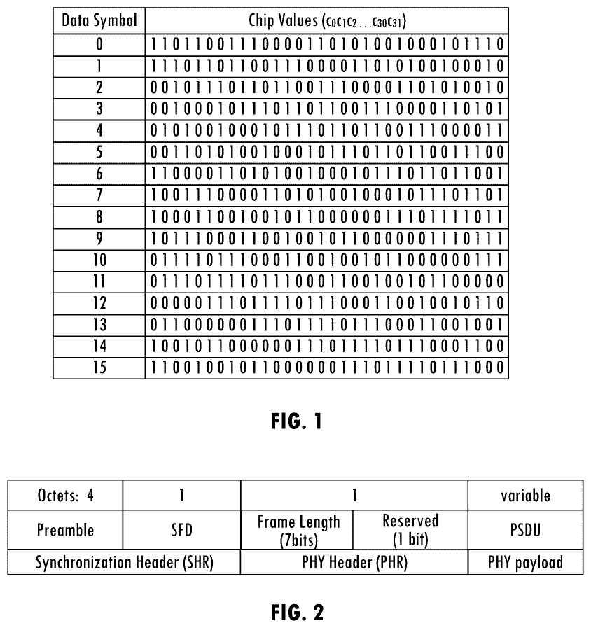

Before describing details of embodiments of the DSSS receiver and use thereof, some background on the signals being demodulated is provided. IEEE Std. 802.15.4 Offset-Quadrature Phase Shift Keying (O-QPSK) utilizes half-sine-shaped O-QPSK, which is equivalent to minimum-shift keying (MSK) modulation. The use of DSSS increases the signal bandwidth to gain a lower bit error rate for the same received signal-to-noise (SNR) ratio. DSSS reduces effects of interference by spreading four bits into thirty-two-chip pseudo-random noise (PN) sequences. IEEE Std. 802.15.4 O-QPSK uses 16 symbols. Each symbol includes 32 chips. Each symbol represents four bits. Each symbol is mapped into a nearly orthogonal 32-chip sequence as specified in the table shown in FIG. 1. The baud rate is 250 kbps, the chip rate is 2 Mchips per second, and the symbol rate is 62.5 k symbols per second.

IEEE Std. 802.15.4 O-QPSK transmits data in a packet shown in FIG. 2. The packet includes a preamble field composed of eight symbol zeros and a Start of Frame Delimiter (SFD) field (i.e., a synchronization word) that is composed of predefined bits (e.g., ‘11100101’) indicating the end of the preamble and the start of packet data. The eight symbol preamble and two symbol synchronization word can be used for initial timing/frequency acquisition.

For DSSS, the chip sequences representing each data symbol are modulated onto the carrier using O-QPSK with half-sine pulse shaping. Even-indexed chips are modulated onto the in-phase (I) carrier, and odd-indexed chips are modulated onto the quadrature-phase (Q) carrier. In the 2450 MHz and 2380 MHz frequency bands, since each data symbol is represented by a 32-chip sequence, the chip rate is 32 times the symbol rate.

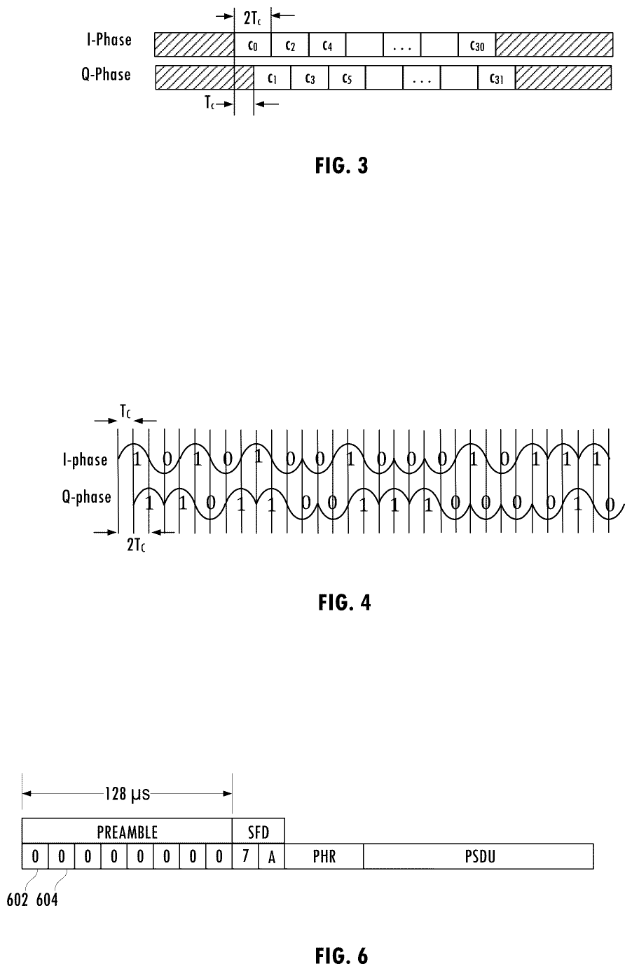

Referring to FIG. 3, to form the offset between I-phase and Q-phase chip modulation, the Q-phase chips are delayed by the time T_{c} with respect to the I-phase chips, where Tc is the inverse of the chip rate. In the 2450 MHz, 915 MHz, 868 MHz, and 2380 MHz frequency bands, the half-sine pulse shape is used to represent each baseband chip and is as follows:

$$p ( t ) = \{ \begin{matrix}sin ( π \frac{t}{2 {T}_{c}} ) , 0 \leq t \leq 2 {T}_{c} \\ 0 , otherwise\end{matrix} .$$

FIG. 4 illustrates a sample baseband chip sequence (the zero sequence) with half-sine pulse shaping. The baseband O-QPSK signal is:

$$s ( t ) = {\sum }_{n} {I}_{n} g ( t - 2 n {T}_{c} ) + j {\sum }_{n} {Q}_{n} g ( t - 2 n {T}_{c} - {T}_{c} ) .$$

The baseband signals are converted to radio frequency signals: S_{RF}(t)=Re{s(t)e^{j2πf}^{_{ctx}}^{t}}, where f_{ctx} is the carrier frequency at the transmitter. The chip duration is T_{c}=0.5 μs, from which the symbol rate can be inferred (1/Tc)/32=62.5 kilo-symbols/s and the data rate of the O-QPSK PHY is 62.5×4=250 kb/s.

The chip sequences are modulated onto the carrier using O-QPSK with half-sine pulse shaping, which is equivalent to MSK modulation with a modulation index h=0.5. But to make the MSK strictly equivalent to the specified O-QPSK format, data is coded and the MSK/O-QPSK chip coder is as follows. The binary chip in the table in FIG. 1 is translated into signed data through the relations:

| c[k] | c_oqpsk[k] |
|---|---|
| 1 | +1 |
| 0 | −1 |

The signed MSK chip data c_msk_signed[k] can be calculated by:

$$c\_msk \_signed [ 2 \times n ] = c\_oqpsk [ 2 \times n + 1 ] \times c\_oqpsk [ 2 \times n ] ;$$

$$c\_msk \_signed [ 2 \times n + 1 ] = - c\_oqpsk [ 2 \times n + 2 ] \times c\_oqpsk [ 2 \times n + 1 ] ,$$

where n=0, 1, 2, 3, 4, . . . ;
k=2×n if k is an even number; k=2×n+1 if k is an odd number.
The binary MSK chip c_msk[k] can be translated by

| c_msk_signed[k] | c_msk[k] |
|---|---|
| +1 | 1 |
| −1 | 0 |

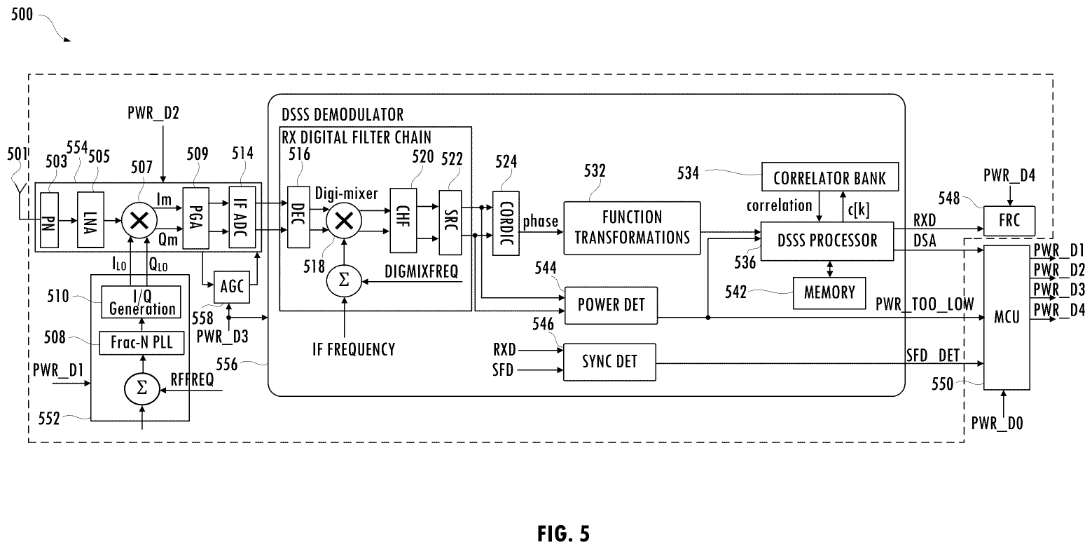

FIG. 5 illustrates a high-level block diagram of an embodiment of duty-cycle-based receiver 500 included in a wireless communications device. Duty-cycle-based receiver 500 has the capability for fast signal arrival detection. Duty-cycle-based receiver 500 uses a heterodyne (intermediate frequency (IF) sampling) receive architecture. A series of passive and active devices down-converts the carrier radio frequency (RF) to either a low or high intermediate frequency (IF) for sampling while maintaining signal integrity. Antenna 501 provides an RF signal to passive network 503, which provides impedance matching, filtering, and electrostatic discharge protection. Low-noise amplifier 505 amplifies the signals from passive network 503 without substantial degradation to the signal-to-noise ratio and provides the amplified RF signals to mixer 507. Mixer 507 performs frequency translation or shifting of the RF signals, using signals generated by RF clock synthesizer 552. RF clock synthesizer 552 uses a fractional-N phase-locked loop (PLL) 508 and I/Q generation block 510, which converts the local oscillator signal from fractional-N PLL 508 to I_{LO} and Q_{LO} signals for use by mixer 507.

Mixer 507 provides the translated output signal as a set of two signals, an in-phase (Im) signal, and a quadrature (Qm) signal, to programmable gain amplifiers (PGA) 509. The Im and Qm signals are analog time-domain signals. In at least one embodiment of duty-cycle-based receiver 500, PGA amplifiers 509 and filters (not separately illustrated) provide amplified and filtered versions of the Im and Qm signals to intermediate frequency analog-to-digital converter 514, which converts those versions of the Im and Qm signals to digital signals. Intermediate frequency analog-to-digital converter 514 provides digital I and Q signals to a receiver digital filter chain. The receiver digital filter chain includes decimator 516, which supplies signals to digital mixer 518. Digital mixer 518 frequency mixes the signal from the intermediate frequency to baseband and channel filter 520 provides filtering to reduce effects of channel interferers. The bandwidth of channel filter 520 is configurable to combine a wide frequency offset tracking range with optimized sensitivity. An embodiment selects the IF frequency to be 1.369977 MHz. In an embodiment, the initial bandwidth of channel filter 520 is 2.2 MHz and after signal arrival detection is triggered, bandwidth of channel filter 520 is switched to 1.8 MHz. Other bandwidths may be selected for channel filter 520 in other embodiments. The sampling rate converter (SRC) 522 scales the channel filter output sample rate with respect to the expected chip rate to an integer value. That reduces or eliminates the sample phase jitter but does not guarantee that the chip sample phase is correct. A timing loop is required to provide chip timing information. COordinate Rotation DIgital Computer (CORDIC) 524 converts the I and Q signals to phase and amplitude. In general, a CORDIC implements known techniques to perform calculations, including trigonometric functions and complex multiplies, without using a multiplier. The only operations the CORDIC uses are addition, subtraction, bit-shift, and table-lookup operations to implement the arctangent function. In other embodiments, a digital signal processor executing firmware or custom circuit is used. In an embodiment, duty-cycle-based receiver 500 provides amplitude information to a received signal strength indicator (RSSI) block (not shown). CORDIC 524 also supplies phase information to function transformations block 532.

In an embodiment, function transformations block 532 transforms the phase signal into one chip and multi-chip (from 2 to 6 chips) differential detections, averages a one-chip phase difference between two adjacent samples (interpretation), and provides a second order differentiation. DSSS demodulator 556 also includes correlator bank 534 that computes correlation of the transformations received from the function transformations block 532 with the corresponding template signals c(k) for the duration of the whole symbol sequence. The correlator bank also performs as an “average filter” to estimate frequency offset. DSSS processor 536 generates template signals c[k] based on the pre-defined DSSS symbol-to-chip table. DSSS processor 536 determines which symbol the received signal is most likely to be (maximum likelihood) based on the output of correlator bank 534. This soft decision detection of the DSSS code achieves a more than 2 dB improvement over other approaches. DSSS processor 536 determines whether the first preamble symbol is detected in a one-symbol observation period. After the first symbol is detected, a coarse frequency offset error (FOE) is fed back to digital mixer 518 or frac-N PLL 508. In addition, the bandwidth of channel filter 520 is narrowed to improve sensitivity following the detection of the first preamble symbol for use in detecting the second preamble symbol. DSSS demodulator 556 is also used for timing/frequency acquisition and tracking.

In some embodiments, DSSS processor 536 performs a variety of functions (e.g., logic, arithmetic, etc.) needed for demodulation and other signal processing tasks. DSSS processor 536 may also use the demodulated data in a program, routine, or algorithm (whether in software, firmware, hardware, or a combination thereof) to perform desired control or data processing tasks. In an embodiment, DSSS processor 536 includes one or more processors such as a microcontroller(s) and software and/or firmware to perform the desired demodulation functions described herein. Memory 542 stores software and firmware for use by DSSS processor 536 to perform various tasks and stores data supplied to or generated by DSSS processor 536. Memory 542 may include multiple kinds of memory in various embodiments including dynamic random-access memory (DRAM), static random-access memory (SRAM), and/or non-volatile memory (NVM), according to system needs. In addition, while DSSS processor 536 can access memory 542, in embodiments, other system components, such as the functions transformations block 532, correlator bank can access memory 542, and microcontroller unit 550 can access memory 542.

Slow signal arrival detection can make it very difficult to achieve fast frequency hopping in an environment requiring monitoring multiple communication systems such as an IoT environment that uses multiple physical interfaces. In a conventional non-coherent DSSS demodulator, the packet error rate sensitivity is limited by synchronization word error rate (SER). The poor SER performance usually comes from the variation of initial frequency error estimation and initial timing detection. Detection signal DSA is used to indicate if a DSSS preamble signal is being received. In a multi-physical interface environment, the system requires fast signal detection to avoid missed transmissions. Fast detection needs a short correlation observation period. However, in low SNR environment, the signal to-be-detected is very weak compared to the noise. Embodiments described herein provide fast DSSS signal arrival detection for channel scan/switching and antenna diversity applications. Embodiments also provide more accurate initial timing and frequency offset estimation and more robust DSSS de-spreading to make the demodulator more sensitive. Embodiments, such as the DSSS demodulator illustrated in FIG. 5 provide a low cost, low power, and configurable correlator bank for DSSS demodulation.

Duty-cycle-based receiver 500 accomplishes signal arrival detection within one preamble symbol. After one symbol detection, correlator bank 534 is reconfigured on-the-fly to determine a coarse frequency offset. Signal arrival detection is then confirmed with a second preamble signal. Early exit provisions allow false detection to be dealt with quickly. After signal arrival detection is confirmed, duty-cycle-based receiver 500 extends the correlation length for robust initial timing detection. During the initial timing detection stage, duty-cycle-based receiver 500 configures correlator bank 534 as matched finite-impulse response (FIR) filters to process two function transformations of each of four symbols. That step improves reliability of initial timing detection and rejects unnecessary false detections. Further, after frequency offset estimation and timing detection, duty-cycle-based receiver 500 reconfigures correlator bank 534 as matched FIR filters on-the-fly to decode (e.g., despread) received DSSS symbols and track timing drift.

Referring to FIGS. 5 and 6, in an embodiment, duty-cycle-based receiver 500 uses received preamble symbol 602 (e.g., “0”) for signal arrival detection and desired channel power detection. Duty-cycle-based receiver 500 uses received preamble symbol 604, which follows received preamble symbol 602, to qualify the signal arrival detection and reject a false signal arrival detection. Coarse timing estimation and fine residual frequency offset estimation use the last two zero symbols of the preamble and the two SFD symbols (e.g., “7A”), which together have the value of “007A”. In at least one embodiment, sync detector 546 performs a correlation of received data RXD provided by DSSS processor 536 and the predetermined symbol values of the SFD field (e.g., “7A”) to generate control signal SFD_DET. Sync detector 546 asserts control signal SFD_DET in response to the correlation exceeding a predetermined threshold value, thereby indicating detection of an IEEE Std. 802.15.4 signal, and deasserts control signal SFD_DET otherwise. Additional details of DSSS demodulator 556 including function transformations 532, correlator bank 534, DSSS processor 536, and generation of control signal DSA are described further in U.S. patent application Ser. No. 18/217,015, entitled “Non-Coherent DSSS Demodulator with Fast Signal Arrival Detection and Improved Timing and Frequency Offset Estimation,” filed on Jun. 30, 2023, and in U.S. patent application Ser. No. 18/217,019, entitled “Configurable Correlator Bank for a Non-Coherent DSSS Demodulator,” filed on Jun. 30, 2023, which applications are incorporated herein by reference.

In at least one embodiment, duty-cycle-based receiver 500 is partitioned into a plurality of power domains that may be selectively disabled by microcontroller unit 550 to reduce power consumption. In an embodiment, microcontroller unit 550 executes software and/or firmware to perform the desired functions described herein. In at least one embodiment, each of five major blocks of duty-cycle-based receiver 500 is associated with a corresponding power domain and a corresponding power domain control signal. Microcontroller unit 550 is in power domain 0, which is enabled in response to control signal PWR_D0 received from an external control circuit. During a duty cycle mode of operation, power domain 0 is always on during the on-time and the off-time of the receiver duty cycle. RF synthesizer 552 operates in power domain 1 and microcontroller unit 550 enables or disables the power domain by asserting control signal PWR_D1. RF receiver circuit 554 operates in power domain 2 and microcontroller unit 550 enables or disables power domain 2 by asserting control signal PWR_D2. DSSS demodulator 556 and automatic gain control 558 operate in power domain 3 and microcontroller unit 550 enables or disables power domain 3 by asserting control signal PWR_D3. Frame controller 548 operates in power domain 4 and microcontroller unit 550 enables or disables power domain 4 by asserting control signal PWR_D4. In an embodiment, duty-cycle-based receiver 500 operates in a duty cycle mode to reduce power consumption of power domains 1, 2, 3, and 4. No power is saved from power domain 0 in the duty cycle mode since microcontroller unit 550 is required to control the on-time and off-time of portions of duty-cycle-based receiver 500. For an exemplary embodiment, operation of each power domain is summarized as follows:

| | | POWER | POWERUP |
|---|---|---|---|
| POWER | | CONSUMPTION | TIME |
| DOMAIN | MODULE | (mW) | (μs) |
| 1 | RF clock synthesis | 2 | 20 |
| 2 | RF receiver circuit | 2 | 14 |
| 3 | AGC/DSSS demodulator | 0.85 | <0.1 |
| 4 | FRC | 0.15 | <0.1 |

In an embodiment, power domains 1-4 have a combined power consumption of 5 mW without operating the duty cycle mode in the receiver search state with all power domains being enabled. In other embodiments, the receiver circuitry is partitioned differently into different domains. Power consumption, powerup times, and power consumption savings of the duty cycle mode of operation will vary according to the embodiment. In at least one embodiment, an individual power domain is controlled by gating a clock signal provided to that power domain. In other embodiments, the individual power domain is controlled by selectively disabling a power supply provided to the circuitry of the power domain.

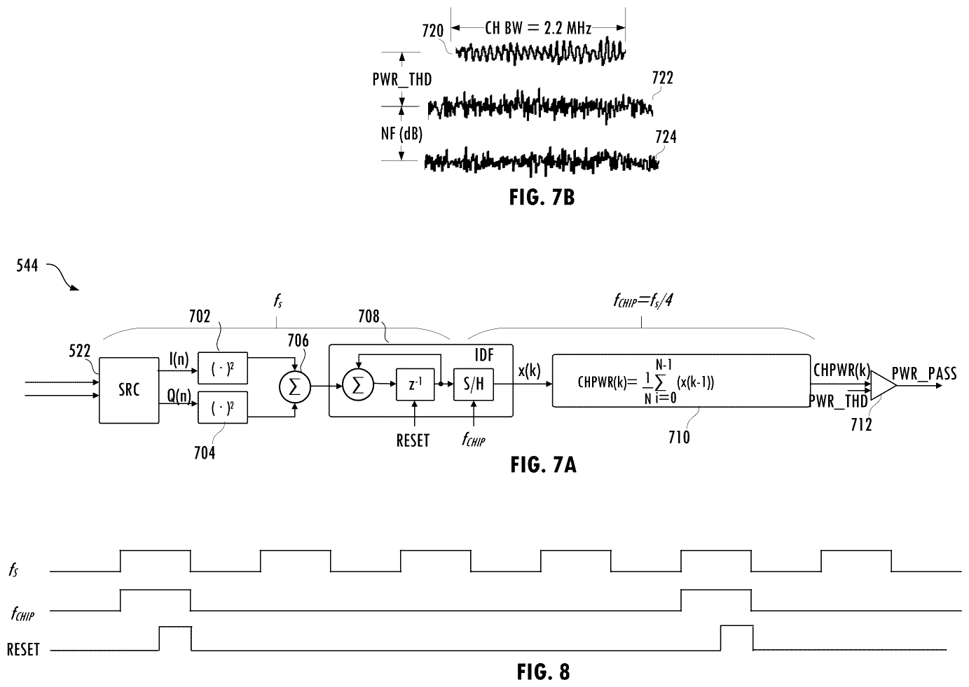

Referring to FIGS. 5-8, in at least one embodiment, power detector block 544 receives the I and Q signals from sample rate converter 522 of the receiver digital filter chain and generates signal PWR_TOO_LOW, which is asserted in response to PWR_PASS being deasserted. The channel power is defined as the sum of all power in a channel (e.g., defined in IEEE Std. 802.15.4) within a defined bandwidth (e.g., 2.2 MHz). Power detector block 544 detects instantaneous power of the received signal and averages it over a predetermined period to obtain an average of the received signal power. Square function circuit 702, square function circuit 704, and summing circuit 706 compute the instantaneous power of samples of the received signal at sample rate fₛ. In at least one embodiment, square function circuit 702 and square function circuit 704 are replaced by an absolute value function or an amplitude operation of a CORDIC. Integrate and dump filter 708 creates a cumulative sum of the discrete-time input signal, while control signal RESET clears the sum to zero according to a predetermined schedule. Integrate and dump filter 708 updates signal x(k) at the chip rate (i.e., f_{CHIP}, e.g., once per every four samples). Moving average filter 710 provides an average received power in the channel of CHPWR(k):

$$CHPWR ( k ) = \frac{1}{N} {\sum }_{i = 0}^{N - 1} ( x ( k - i ) ) .$$

Comparator 712 asserts signal PWR_PASS in response to average received signal power CHPWR (k) exceeding predetermined value PWR_THD and deasserts signal PWR_PASS otherwise.

In at least one embodiment, the Noise Figure (NF) is the amount of noise power added by the electronic circuitry in the receiver to thermal noise power 724 at the input of the receiver. Thermal noise 724 at the input to the receiver passes through to DSSS demodulator 556. Thermal noise 724 is present in the receiver channel and cannot be removed. The NF of circuits in the receiver such as amplifiers and mixers, adds additional noise to the receive channel and raises noise at the demodulator to noise floor 722. In order to achieve the desired quality of the demodulated signal, e.g., desired channel signal 720, average received power CHPWR(k) must be higher than the noise floor by value PWR_THD.

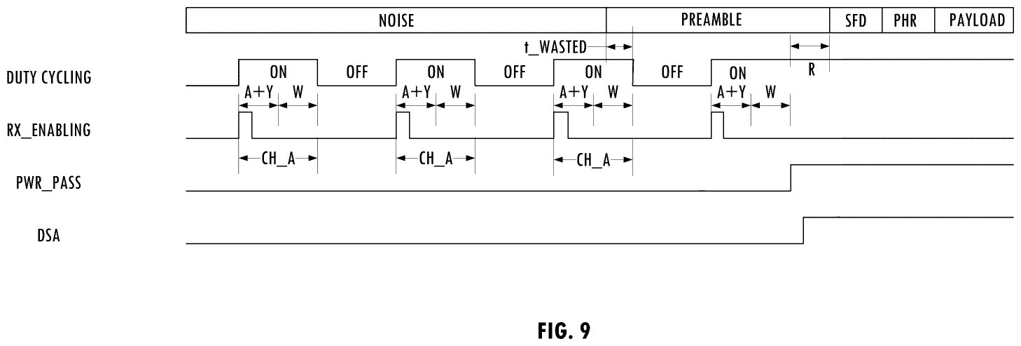

Referring to FIGS. 5 and 9, in an embodiment microcontroller unit 550 periodically enables and disables duty-cycle-based receiver 500 according to a duty cycle. During an on-time of the duty-cycle, RF receiver circuit 554 takes interval A to power up. In an embodiment, interval A is the maximum of the time it takes duty-cycle-based receiver 500 to lock the local oscillator frequency after powering up RF receiver circuit 554 from the powered-down state and the time that it takes all of the RF receiver chain circuitry to power up and fully settle. Interval Y includes the automatic gain control settling time and propagation delay of the receiver digital filter chain until the signal becomes available for processing in the demodulator. This delay is mostly picked up in the automatic gain control and the channel filter. Interval W is a power detection interval. If only noise is detected (e.g., PWR_TOO_LOW=‘1’), then microcontroller unit 550 powers off duty-cycle-based receiver 500. If during an on-time of the duty cycle, duty-cycle-based receiver 500 only receives a few chips of the preamble and those few chips are insufficient to detect the signal (e.g., PWR_TOO_LOW=‘1’), then duty-cycle-based receiver 500 powers down and preamble chips in interval t_WASTED are unused. If during an on-time of the duty cycle, duty-cycle-based receiver 500 receives enough chips of the preamble that are sufficient to detect the signal (e.g., PWR_TOO_LOW=‘0’), then duty-cycle-based receiver 500 asserts control signal PWR_PASS, and suspends duty-cycling. Duty-cycle-based receiver 500 performs a fast DSSS preamble arrival detection and frequency offset estimation over interval R. If the signal arrival is detected, then DSSS processor 536 asserts control signal DSA.

In the exemplary embodiment, the on-time (i.e., ON) equals A+Y+W, and t_WASTED+off-time+A+Y+W+R is less than 128 μs—(t_WASTED+A+Y+W+R). Duty cycle-based power savings for that embodiment can be computed as a percentage: off-time/(on-time+off-time) and the duty-cycle-based power savings is approximately the total power consumption x power saving percentage. In an exemplary embodiment, t_WASTED=8 μs, the scan window is 40 μs (A=20 μs, Y=4 μs, W=16 μs), R=32 μs, on-time=40 μs, and off-time=48 μs. Therefore, the power savings of duty-cycle-based operation for that embodiment is 2.7 mW.

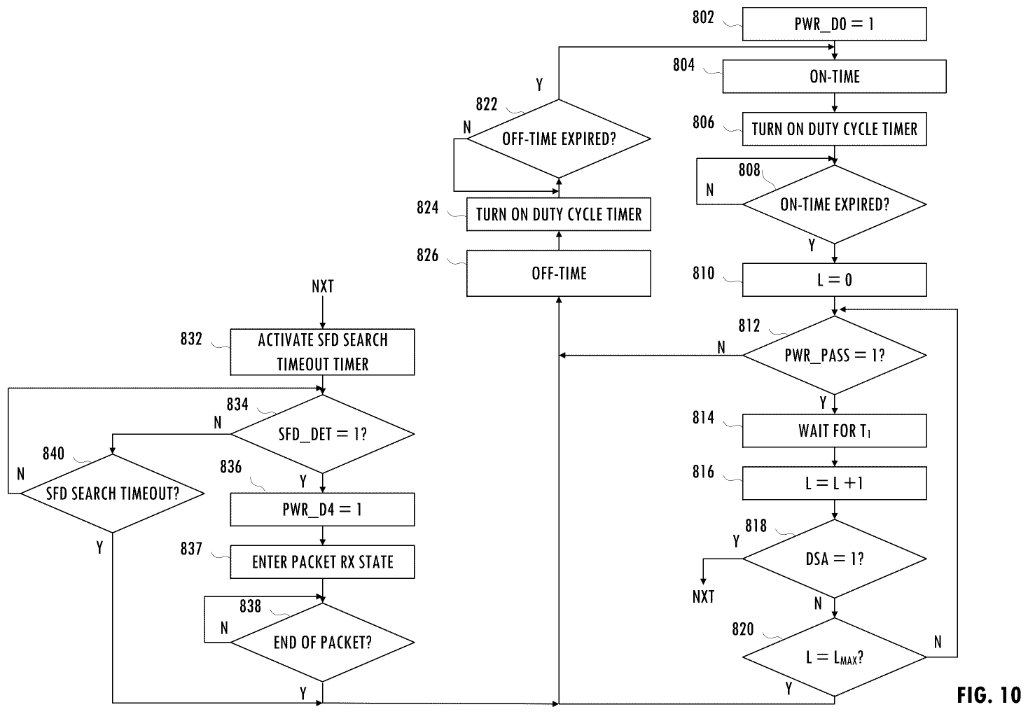

Referring to FIGS. 5 and 10, exemplary duty-cycle-based DSSS demodulator operation includes microcontroller unit 550 (or other state machine) being initialized in response to duty-cycle-based receiver 500 asserting control signal PWR_D0 to enable power domain 0. Microcontroller unit 550 and any other essential circuitry (i.e., circuitry that cannot be powered off for proper operation) are in power domain 0. Other power domains are disabled by corresponding control signals (e.g., PWR_D1=0, PWR_D2=0, PWR_D3=0, and PWR_D4=0) (802). Microcontroller unit 550 enables an on-time of the duty cycle, e.g., enables power domains 1, 2, and 3 by asserting control signals PWR_D1, PWR_D2, and PWR_D3 (804), enables a duty cycle timer, and sets a predetermined on-time timeout threshold, e.g., ON=A+Y+W (806). Microcontroller unit 550 polls the duty cycle timer to determine whether the predetermined on-time has expired (808). If the predetermined on-time has not expired, then microcontroller unit 550 waits until the predetermined on-time has expired. When the predetermined on-time has expired, then the state machine initializes variable, L (e.g., L=0) (810). If insufficient power is detected (e.g., PWR_TOO_LOW=1 or PWR_PASS=0) (812), then the state machine enters an off-time of the duty cycle and powers down domains 1, 2, and 3 (e.g., by deasserting control signals PWR_D1, PWR_D2, and PWR_D3) (826). Then, microcontroller unit turns on the duty cycle timer and sets the predetermined off-time timeout threshold, e.g., OFF=128—(t_WASTED+A+Y+W+R (824), and waits until the off-time expires (822). In response to expiration of the off-time, microcontroller unit 550 starts the duty cycle timer again for the on-time of the duty cycle (804).

If sufficient power is detected (i.e., PWR_PASS=1) (812), then microcontroller unit 550 waits for predetermined interval T₁ (e.g., 4 μs) (814) and increments variable L (816). If control signal DSA is asserted indicating detection of signal arrival (818), then microcontroller unit 550 causes duty-cycle-based receiver 500 to activate the start-of-frame delimiter search timeout timer (832). Microcontroller unit 550 determines whether the start-of-frame delimiter has been detected by sync detector 546 (834). If by sync detector 546 has not detected the start-of-frame delimiter, then microcontroller unit 550 continues to wait for detection of the start-of-frame delimiter until the start-of-frame delimiter search times out (840). If the start-of-frame delimiter search times out, then microcontroller unit 550 starts the off-time of the duty cycle and powers down domains 1, 2, and 3 (e.g., PWR_D1=0, PWR_D2=0, and PWR_D3=0) (826), turns on the duty cycle timer and sets the off-time timeout threshold, e.g., OFF=128—(t_WASTED+A+Y+W+R (824), and waits until the off-time expires (822). In response to expiration of the off-time, microcontroller unit 550 starts the on-time of the duty cycle again (804).

If the start-of-frame delimiter has been detected (834), then microcontroller unit 550 enables power domain 4 by asserting the corresponding control signal (e.g., PWR_D4=1) (836) to enter a packet receive state (837) and microcontroller unit 550 waits until duty-cycle-based receiver 500 detects an end of the packet (838). When duty-cycle-based receiver 500 detects the end of the packet, microcontroller unit 550 turns off the on-time of the duty cycle, starts the off-time of the duty cycle, powers down power domains 1, 2, 3, and 4 using corresponding control signals (e.g., PWR_D1=0, PWR_D2=0, PWR_D3=0, and PWR_D4=0) (826), enables the duty cycle timer for the off-time, sets the off-time timeout threshold, e.g., OFF=128—(t_WASTED+A+Y+W+R (824), and waits until the off-time expires (822). In response to expiration of the off-time, microcontroller unit 550 starts the on-time of the duty cycle again (804).

If control signal DSA is deasserted (818), then microcontroller unit 550 determines if a maximum iteration of wait time L_{MAX} is reached (e.g., L=4) (820). If the maximum iteration is not reached, then microcontroller unit 550 continues to wait for sufficient power to be detected (812). If the maximum iteration is reached without sufficient power being detected (812), then microcontroller unit 550 turns off the on-time of the duty cycle and powers down domains 1, 2, and 3 (e.g., PWR_D1=0, PWR_D2=0, and PWR_D3=0) (826), starts the duty cycle timer for the off-time, sets the off-time timeout threshold, e.g., OFF=128—(t_WASTED+A+Y+W+R (824), and waits until the off-time expires (822). In response to expiration of the off-time, microcontroller unit 550 starts the on-time of the duty cycle again (804).

Thus, techniques for reducing power consumption of a DSSS receiver by using duty cycle based operation and selectively disabling power domains of the DSSS receiver have been described. The description of the invention set forth herein is illustrative and is not intended to limit the scope of the invention as set forth in the following claims. For example, while the invention has been described in an embodiment in which a heterodyne DSSS receiver is used, one of skill in the art will appreciate that the teachings herein can be utilized with other receiver architectures. The terms “first,” “second,” “third,” and so forth, as used in the claims, unless otherwise clear by context, are to distinguish between different items in the claims and do not otherwise indicate or imply any order in time, location or quality. For example, “a first received signal” and “a second received signal,” do not indicate or imply that the first received signal occurs in time before the second received signal. Variations and modifications of the embodiments disclosed herein may be made based on the description set forth herein, without departing from the scope of the invention as set forth in the following claims.

1. A method for operating a wireless communications device, the method comprising:
periodically enabling a radio frequency receiver circuit, the radio frequency receiver circuit being partitioned into a plurality of power domains; and
controlling power consumption of the radio frequency receiver circuit by selectively disabling at least one of the plurality of power domains during an on-time of the radio frequency receiver circuit, the power consumption being controlled based on signal arrival detection and an average received signal power.

2. The method as recited in claim 1, further comprising:
determining the average received signal power based on a comparison of a predetermined threshold to a moving average of an estimated instantaneous power of a received signal.

3. The method as recited in claim 1, wherein controlling the power consumption comprises:
configuring the radio frequency receiver circuit in a packet receive state,
wherein the power consumption is controlled further based on detection of a synchronization word in a received packet.

4. The method as recited in claim 1, wherein controlling the power consumption comprises:
disabling at least one of the plurality of power domains in response to a timeout of a synchronization word detection window.

5. The method as recited in claim 3, wherein controlling the power consumption further comprises:
disabling a power domain of the plurality of power domains prior to detection of the synchronization word; and
enabling the power domain in response to the detection of the synchronization word.

6. The method as recited in claim 1, wherein controlling the power consumption comprises:
disabling at least one of the plurality of power domains in response to detecting an end of a packet.

7. The method as recited in claim 1, wherein the plurality of power domains includes a local oscillator power domain, a radio frequency front-end circuit power domain, an automatic gain control and a demodulator power domain, and a frame controller power domain.

8. The method as recited in claim 1, further comprising:
detecting signal arrival based on a real time arrival correlator bank configuration of a correlator bank and in response to a correlation of a plurality of transformations corresponding to a received symbol to respective template signals.

9. A wireless communications device comprising:
a radio frequency receiver circuit configured to generate a signal arrival detection signal and an average received signal power signal, the radio frequency receiver circuit being partitioned into a plurality of power domains; and
a controller configured to periodically enable the radio frequency receiver circuit and configured to generate a power domain control signal for at least one of the plurality of power domains of the radio frequency receiver circuit based on the signal arrival detection signal and the average received signal power signal.

10. The wireless communications device as recited in claim 9, wherein the radio frequency receiver circuit comprises:
a demodulator circuit configured to detect signal arrival based on a real time arrival correlator bank configuration of a correlator bank and in response to a correlation of a plurality of transformations corresponding to a received symbol to respective template signals.

11. The wireless communications device as recited in claim 10, wherein the demodulator circuit is further configured to determine average received signal power based on a comparison of a predetermined threshold to a moving average of an estimated instantaneous power of a received signal.

12. The wireless communications device as recited in claim 11, wherein the demodulator circuit is further configured to detect a synchronization word in a received packet and the power domain control signal is further based on an indication of detection of the synchronization word.

13. The wireless communications device as recited in claim 12, wherein the controller is further configured to disable a power domain of the plurality of power domains prior to detection of the synchronization word and to enable the power domain in response to the detection of the synchronization word.

14. The wireless communications device as recited in claim 12, wherein the controller is further configured to disable at least one of the plurality of power domains in response to a timeout of a synchronization word detection window.

15. The wireless communications device as recited in claim 12, wherein the controller is further configured to disable at least one of the plurality of power domains in response to detecting an end of a packet.

16. The wireless communications device as recited in claim 9, wherein the plurality of power domains includes a local oscillator power domain, a radio frequency front-end circuit power domain, an automatic gain control and a demodulator power domain, and a frame controller power domain.

17. The wireless communications device as recited in claim 16, wherein the radio frequency receiver circuit comprises:
a radio frequency receiver front-end circuit associated with a first power domain of the plurality of power domains;
a local oscillator circuit coupled to the radio frequency receiver front-end circuit associated with a second power domain of the plurality of power domains;
an automatic gain control circuit associated with a third power domain of the plurality of power domains;
a demodulator associated with the third power domain of the plurality of power domains; and
a frame controller circuit associated with a fourth power domain of the plurality of power domains.

18. The wireless communications device as recited in claim 17,
wherein the controller is associated with an additional power domain, the additional power domain being a constant power domain, and
wherein the controller is further configured to selectively enable the first, second, third, and fourth power domains during an on-time of the radio frequency receiver circuit.

19. An apparatus comprising:
means for receiving and demodulating a radio frequency signal; and
means for periodically enabling and controlling power consumption of the means for receiving and demodulating the radio frequency signal based on signal arrival detection and an average received signal power.

20. The apparatus as recited in claim 19, wherein the power consumption of the means for receiving and demodulating the radio frequency signal is controlled further based on detection of a synchronization word in a received packet.
